(19) United States
(12) Patent Application Publication
(10) Pub. No.: US 2026/0204467 A1
(43) Pub. Date: Jul. 16, 2026

(54) SIDE CLAMP

(71) Applicant: HD Hyundai Electric Co., Ltd., Seongnam-si (KR)

(72) Inventors: Jin Woo LEE, Seoul (KR); Chang UK Kim, Seoul (KR)

(73) Assignee: HD Hyundai Electric Co., Ltd., Seongnam-si (KR)

(21) Appl. No.: 19/262,123

(22) Filed: Jul. 8, 2025

(30) Foreign Application Priority Data
Jan. 15, 2025 (KR) 10-2025-0006353

(51) Int. Cl. H01F 27/24

(52) U.S. Cl. CPC H01F 27/24

(57) ABSTRACT

A side clamp disposed between a pair of main clamps, with each main clamp provided on a side of an upper core or a lower core along a length direction of the upper core or the lower core, and configured to face a leg core arranged at each end of the upper core or the lower core. The side clamp includes at least one transverse plate horizontally connecting opposing surfaces of the pair of main clamps, and a side plate provided at each end of the transverse plate along a length direction of the transverse plate, and configured to contact each of the opposing surfaces of the pair of main clamps. The side clamp may prevent waste of manpower by performing the process without welding, may increase space efficiency and production efficiency, and may be easily installed on a transformer or reactor.

### CROSS REFERENCE TO RELATED APPLICATION

This application claims priority to Korean Patent Application No. 10-2025-0006353 (filed on January 15, 2025), which is hereby incorporated by reference in its entirety.

### BACKGROUND

The present disclosure relates to a side clamp and, more particularly, to a side clamp that can be installed on the core assembly of transformers and reactors.

In general, a transformer core assembly is largely divided into a core, coils, and clamps. Among these three main components, the structural elements that are fastened to maintain the designed shape of the core and coils are called the clamps. A clamp is often composed of a main clamp and a side clamp.

Since the clamps are exposed to various operating situations, the clamps need to be designed to ensure sufficient structural safety.

Side clamps on a transformer are designed to ensure that the core’s designed shape is maintained by considering the maximum acceleration the transformer might experience during transportation.

In other words, the side clamps used in a transformer or reactor are installed to prevent the core from slipping or shifting due to the acceleration of the motion, and conventionally, welding is performed when installing the side clamps.

At this time, because the side clamps are welded to the main clamp of a transformer or reactor and then assembled to the core assembly, the work is performed by multiple workers in groups, and complex work is performed by using a height-adjustable bogie, etc.

For reasons such as the work force arrangement and bogie installation mentioned above, the process of mounting side clamps on transformers or reactors causes delays in other processes, which in turn leads to a decrease in space utilization efficiency and production efficiency.

### Document of Related Art

(Patent Document 1) Korean Patent No. 10-2145839

### SUMMARY

Accordingly, the present disclosure has been made keeping in mind the above problems occurring in the related art, and the present disclosure is intended to provide a side clamp that prevents waste of manpower by performing the process without welding, increases space efficiency and production efficiency, and can be easily installed on transformers or reactors.

In order to achieve the above objective, according to an aspect of the present disclosure, there is provided a side clamp disposed between a pair of main clamps, with each main clamp provided on a side of an upper core or a lower core along a length direction of the upper core or the lower core, and configured to face a leg core arranged at each end of the upper core or the lower core, the side clamp including: at least one transverse plate horizontally connecting opposing surfaces of the pair of main clamps; and a side plate provided at each end of the transverse plate along a length direction of the transverse plate, and configured to contact each of the opposing surfaces of the pair of main clamps.

The side clamp according to an aspect of the present disclosure may further include a back plate provided on a rear side of the transverse plate, and having opposite ends thereof respectively in contact with the opposing surfaces of the pair of main clamps.

The side clamp according to an aspect of the present disclosure may further include at least one longitudinal plate arranged perpendicular to the transverse plate on the transverse plate.

The side clamp according to an aspect of the present disclosure may further include an insulation plate placed between the side plate and a surface of the opposing surfaces of the pair of main clamps, and configured to be capable of insulation.

The side clamp according to an aspect of the present disclosure may further include an insulation block having a shape corresponding to a shape of the leg core and placed between the back plate, the leg core, and the main clamps.

In the side clamp according to an aspect of the present disclosure, the insulation block may be made of wood.

The side clamp according to an aspect of the present disclosure may further include supporting protrusions respectively protruding from the opposing surfaces of the pair of main clamps so as to face each other, and configured to support the insulation block.

The side clamp according to an aspect of the present disclosure may further include movement prevention parts respectively protruding from the opposing surfaces of the pair of main clamps so as to face each other, configured to have a vertical length and to restrict a movement of the side plate.

The side clamp according to an aspect of the present disclosure may further include: an insulation plate placed between the side plate and a surface of the opposing surfaces of the pair of main clamps, and configured to be capable of insulation; and movement prevention parts respectively protruding from the opposing surfaces of the pair of main clamps so as to face each other, configured to have a vertical length and to restrict a movement of the side plate, wherein the insulation plate may include: a first bending part bent in the length direction of the transverse plate while avoiding each of the movement prevention parts; and a second bending part bent in a width direction of the transverse plate from the first bending part while avoiding each of the movement prevention parts.

In the side clamp according to an aspect of the present disclosure, each of the main clamps and the side plate may be coupled to each other by a coupling means.

The present disclosure can prevent waste of manpower by performing the process without welding, can increase space efficiency and production efficiency, and can be easily installed on transformers or reactors.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view showing a side clamp according to an embodiment of the present disclosure installed in a transformer;

FIG. 2 is a perspective view showing a side clamp according to an embodiment of the present disclosure installed in a reactor;

FIG. 3 is a partial excerpt showing part A of FIG. 1;

FIG. 4 is a partial excerpt showing part B of FIG. 2;

FIG. 5 is a partial perspective view showing another embodiment of a side clamp according to an embodiment of the present disclosure;

FIG. 6 is a partial perspective view showing a part of a transformer with a side clamp removed according to an embodiment of the present disclosure;

FIG. 7 is a partial perspective view showing an insulating plate and an insulating material additionally placed in FIG. 6; and

FIG. 8 is an exploded perspective view of FIG. 3 or FIG. 4.

### DETAILED DESCRIPTION

Hereinafter, some embodiments of the present disclosure will be described in detail with reference to exemplary drawings. When adding reference numerals to components in each drawing, it should be noted that the same components are given the same numerals as much as possible even if they are shown in different drawings. In addition, when describing embodiments of the present disclosure, if a specific description of a related known configuration or function is judged to hinder understanding of the embodiments of the present disclosure, the detailed description thereof will be omitted.

In addition, in describing components of the embodiments of the present disclosure, terms such as first, second, A, B, (a), (b), etc. may be used. These terms are only intended to distinguish the components from other components, and the nature, order, or sequence of the components are not limited by the terms. When a component is described as being “connected”, “coupled”, or “connected” to another component, it should be understood that the component may be directly connected or connected to that other component, but that other components may also be “connected”, “coupled”, or “connected” between the components.

Below, a side clamp according to an embodiment of the present disclosure will be described with reference to the attached drawings.

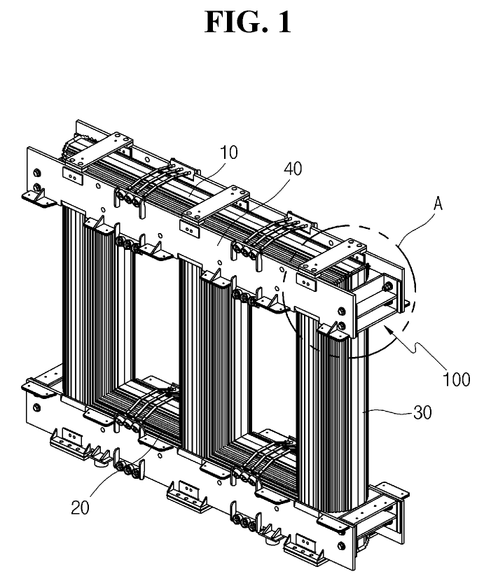

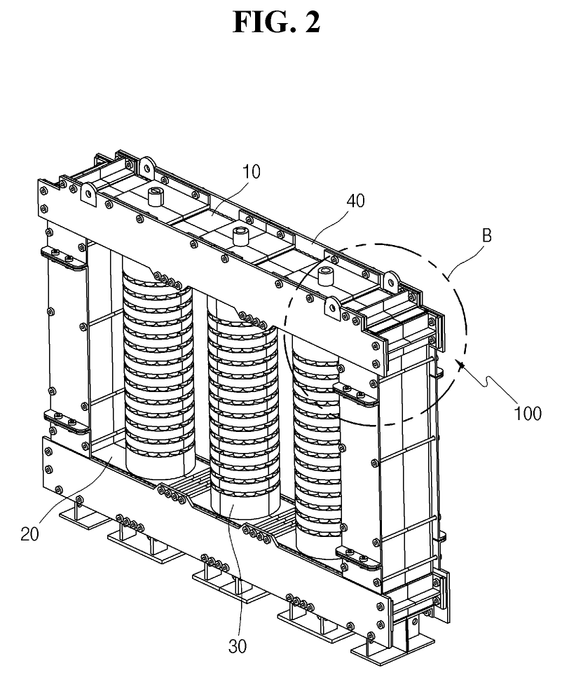

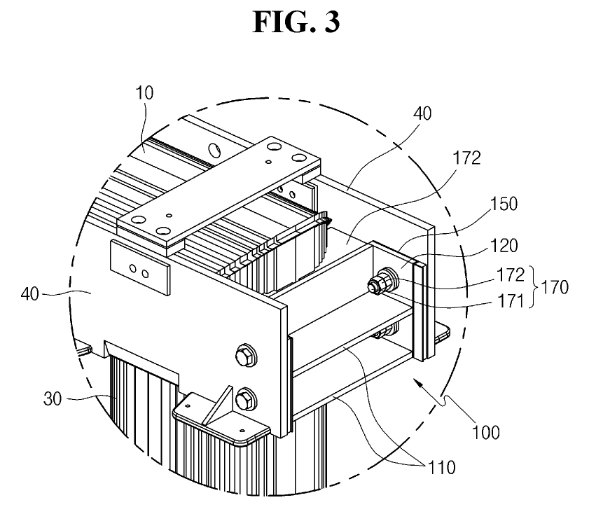

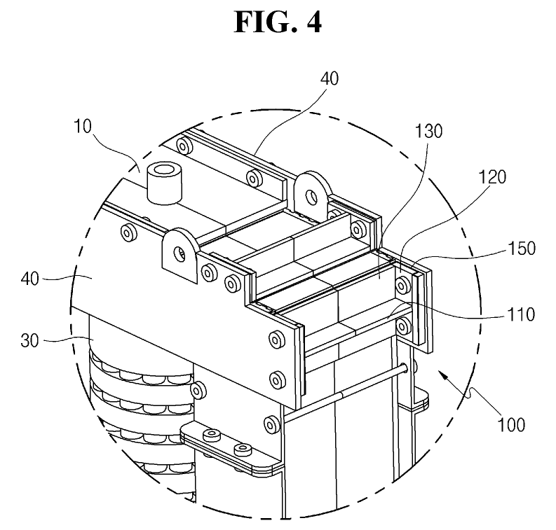

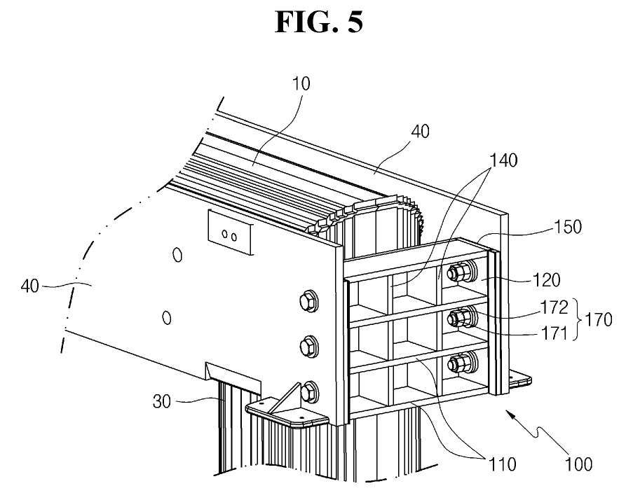

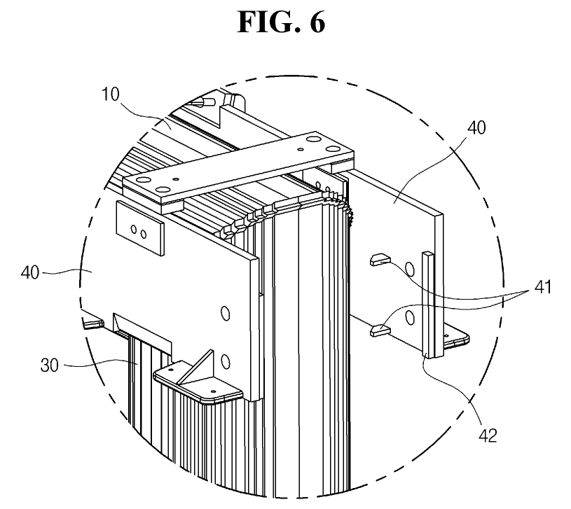

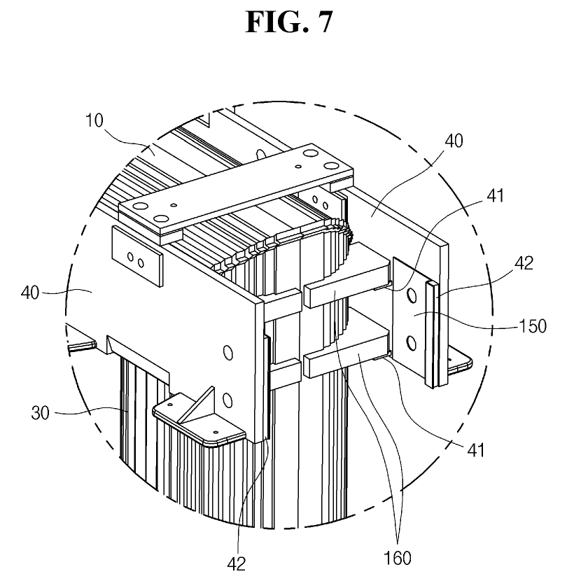

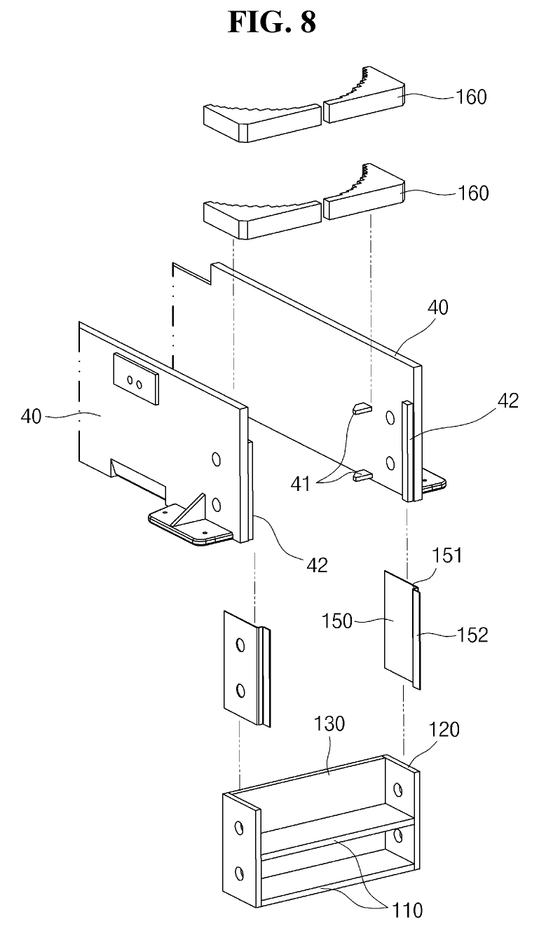

FIG. 1 is a perspective view showing a side clamp according to an embodiment of the present disclosure installed in a transformer; FIG. 2 is a perspective view showing a side clamp according to an embodiment of the present disclosure installed in a reactor; FIG. 3 is a partial excerpt showing part A of FIG. 1; FIG. 4 is a partial excerpt showing part B of FIG. 2; FIG. 5 is a partial perspective view showing another embodiment of a side clamp according to an embodiment of the present disclosure; FIG. 6 is a partial perspective view showing a part of a transformer with a side clamp removed according to an embodiment of the present disclosure; FIG. 7 is a partial perspective view showing an insulating plate and an insulating material additionally placed in FIG. 6; and FIG. 8 is an exploded perspective view of FIG. 3 or FIG. 4.

Referring to FIGS. 1 to 8, a side clamp 100 of the present disclosure may be installed in a transformer 1 or a reactor 2.

As shown in FIGS. 1 to 8, the side clamp 100 according to an embodiment of the present disclosure may be installed on the upper or lower part of a leg core 30 forming a corner with an upper core 10 or a lower core 20 of the transformer 1 or the reactor 2. That is, the transformer 1 or the reactor 2 may have a pair of main clamps 40, with each main clamp 40 disposed on each side of the upper core 10 or the lower core 20 along the length direction of the upper core 10 or the lower core 20, and the side clamp 100 according to an embodiment of the present disclosure may be positioned between the main clamps 40 and may face the leg core 30 positioned at each end of the upper core or the lower core 20.

The side clamp 100 according to an embodiment of the present disclosure may include a transverse plate 110, a side plate 120 and a back plate 130.

The transverse plate 110 may horizontally connect the opposing surfaces of the pair of main clamps 40, and at least one or more transverse plates 110 may be provided.

The side plate 120 may be provided at each end of the transverse plate 110 along the length direction of the transverse plate 110. The side plate 120 may contact each of the opposing surfaces of the pair of main clamps 40.

The back plate 130 may be provided on the rear side of the transverse plate 110, and the opposite ends of the back plate 130 may respectively contact the opposing surfaces of the pair of main clamps 40. In addition, the back plate 130 and the transverse plate 110 or the back plate 130 and the side plate 120 may be interconnected.

Referring to FIG. 5, the side clamp 100 according to an embodiment of the present disclosure may further include at least one longitudinal plate 140. The longitudinal plate 140 may be arranged perpendicular to the transverse plate 110 on the transverse plate 110. At this time, the number of the transverse plates 110 and the longitudinal plates 140 is not limited, and the number may be provided in various ways according to the user's intention.

The side clamp 100 according to an embodiment of the present disclosure may further include an insulation plate 150. The insulation plate 150 may be placed between the side plate 120 and the surface of the main clamp 40 and is capable of insulation.

The insulation plate 150 may include a first bending part 151 and a second bending part 152. The first bending part 151 may be bent in the length direction of the transverse plate 110, that is, in a vertical direction from the transverse plate 110, while avoiding a movement prevention part 42 described later. The second bending part 152 may be bent in the width direction of the transverse plate 110, that is, in a vertical direction from the first bending part 151, while avoiding a movement prevention part 42 described later.

In addition, the side clamp 100 according to an embodiment of the present disclosure may further include an insulation block 160. The insulation block 160 may have a shape corresponding to the shape of the leg core 30 on one side. The insulation block 160 may be placed between the back plate 130, the leg core 30, and the main clamps 40. For reference, the insulation block 160 may be insulated and may be made of wood, but is not limited thereto, and any insulating material may be used. In addition, referring to the drawing, it is preferable that four insulation blocks 160 are placed per one side clamp 100, but the insulation block may be provided in various numbers and shapes depending on the user's intention.

Each of the opposing surfaces of the pair of main clamps 40 may have a supporting protrusion 41. The supporting protrusions 41 may protrude to face each other and support the insulation blocks 160. The supporting protrusion 41 may be provided in correspondence with the number and position of the insulation blocks 160. In addition, the supporting protrusion 41 may also perform the function of a jaw that prevents the back plate from moving backward.

The movement prevention part 42 may protrude from the front end of each of the opposing surfaces of the pair of main clamps 40 so as to face each other. The movement prevention part 42 may be formed with a vertical length and may restrict the side plate 120 from moving forward.

The main clamp 40, the side plate 120, and the insulation plate 150 may be coupled to each other by a coupling means 170. The coupling means 170 may be a bolt 171 and a nut 172. That is, the main clamp 40, the side plate 120, and the insulation plate 150 may each have a coupling hole ((not shown) formed at a corresponding position, and the bolt 171 passes through the coupling holes and the nut 172 may be coupled to the bolt 171. However, any means may be used as the coupling means 170 as long as it can connect and secure the main clamp 40, the side plate 120, and the insulation plate 150.

The above description is only an embodiment for implementing the side clamp according to the present disclosure, and the present disclosure is not limited to the above-described embodiment, and it should be understood that the technical spirit of the present disclosure exists to the extent that anyone with ordinary knowledge in the technical field to which the present disclosure pertains can make various modifications and implement the present disclosure without departing from the gist of the present disclosure claimed in the following claims.

1. A side clamp disposed between a pair of main clamps, with each main clamp provided on a side of an upper core or a lower core along a length direction of the upper core or the lower core, and configured to face a leg core arranged at each end of the upper core or the lower core, the side clamp comprising:
at least one transverse plate horizontally connecting opposing surfaces of the pair of main clamps; and
a side plate provided at each end of the transverse plate along a length direction of the transverse plate, and configured to contact each of the opposing surfaces of the pair of main clamps.

2. The side clamp of claim 1, further comprising:
a back plate provided on a rear side of the transverse plate, and having opposite ends thereof respectively in contact with the opposing surfaces of the pair of main clamps.

3. The side clamp of claim 1, further comprising:
at least one longitudinal plate arranged perpendicular to the transverse plate on the transverse plate.

4. The side clamp of claim 2, further comprising:
at least one longitudinal plate arranged perpendicular to the transverse plate on the transverse plate.

5. The side clamp of claim 1, further comprising:
an insulation plate placed between the side plate and a surface of the opposing surfaces of the pair of main clamps, and configured to be capable of insulation.

6. The side clamp of claim 2, further comprising:
an insulation block having a shape corresponding to a shape of the leg core and placed between the back plate, the leg core, and the main clamps.

7. The side clamp of claim 6, wherein the insulation block is made of wood.

8. The side clamp of claim 6, further comprising:
supporting protrusions respectively protruding from the opposing surfaces of the pair of main clamps so as to face each other, and configured to support the insulation block.

9. The side clamp of claim 1, further comprising:
movement prevention parts respectively protruding from the opposing surfaces of the pair of main clamps so as to face each other, configured to have a vertical length and to restrict a movement of the side plate.

10. The side clamp of claim 1, further comprising:
an insulation plate placed between the side plate and a surface of the opposing surfaces of the pair of main clamps, and configured to be capable of insulation; and
movement prevention parts respectively protruding from the opposing surfaces of the pair of main clamps so as to face each other, configured to have a vertical length and to restrict a movement of the side plate,
wherein the insulation plate comprises:
a first bending part bent in the length direction of the transverse plate while avoiding each of the movement prevention parts; and
a second bending part bent in a width direction of the transverse plate from the first bending part while avoiding each of the movement prevention parts.

11. The side clamp of claim 1, wherein each of the main clamps and the side plate are coupled to each other by a coupling means.
